(19) United States
(12) Patent Application Publication
(10) Pub. No.: US 2018/0162557 A1
(43) Pub. Date: Jun. 14, 2018

(54) STRUT AND JOINT FOR SPACEFRAME STRUCTURE ASSEMBLIES

(71) Applicant: MacDonald, Dettwiler and Associates Corporation, Ste-Anne-de-Bellevue (CA)

(72) Inventors: Steve LAROUCHE, St-Lazare (CA); Gérard SENECHAL, Ste-Anne-de-Bellevue (CA); Stéphane LAMOUREUX, Mirabel (CA)

(21) Appl. No.: 15/838,585

(22) Filed: Dec. 12, 2017

Related U.S. Application Data
(60) Provisional application No. 62/433,624, filed on Dec. 13, 2016.

(51) Int. Cl. B64G 1/22; A47B 47/00; F16M 1/00; H01Q 1/28; F16B 7/18

(52) U.S. Cl. CPC B64G 1/22; A47B 47/0016; F16B 7/185; H01Q 1/28; F16M 1/00

(57) ABSTRACT

A node and a strut connect to one another to form a spaceframe structure, in which the strut has a strut bending stiffness and defines a strut axis. The node has a main body and an arm connecting to and extending from the main body along the strut axis and toward the strut. The arm has a node end attaching to the main body, a strut end connecting to the strut and a midsection extending there between. The midsection includes a neck portion having a neck bending stiffness being less than 20% of the strut bending stiffness. The strut includes primary and secondary sections that axially slidably connect to one another to position them between adjacent respective end-fittings of adjacent nodes, and partially axially overlap and secure to one another and to the end-fittings respectively. At least one of the end-fittings connects to the strut end of the arm.

### CROSS REFERENCE TO RELATED APPLICATIONS

This application claims priority of U.S. Provisional Application for Patent No. 62/433,624 filed Dec. 13, 2016, the content of which is incorporated herein by reference in its entirety.

### FIELD OF THE INVENTION

The present invention relates to the field of spaceframe structures or assemblies, and is more particularly concerned with a strut and a node for spaceframe assembly typically used in spacecraft and antenna structures and the like.

### BACKGROUND OF THE INVENTION

It is well known in the art of spaceframe structures to have a plurality of nodes (or joints or hubs) interconnected with struts such that the assembly has a generally light weight with relatively large structural handling capabilities and high stiffness. Notwithstanding the fact that such spaceframe structures are widely used, they are not always convenient, especially for spacecraft and antenna structure applications (to support antenna reflector(s) and/or antenna feed(s), or the like) due to all of the different design (mechanical, electrical, etc.) and manufacturing (material procurement, assembly, etc.) constraints/requirements which make these structures relatively complex, time consuming and expensive to produce, considering all mechanical analyses (including thermo-elastic distortion (TED) analysis) made using state of the art softwares that are also expensive themselves.

Existing spaceframe structures are usually dictated by a sequence of assembly which can be a logistic challenge, especially in situations requiring repairs and/or replacements of parts.

Accordingly, there is a need for an improved node and/or strut for spaceframe structures.

### SUMMARY OF THE INVENTION

It is therefore a general object of the present invention to provide an improved node and/or strut for spaceframe structures to obviate the above-mentioned problems.

An advantage of the present invention is that the node and/or strut ensure an overall design and manufacturing complexity, lead time and cost of the spaceframe structure to be significantly reduced compared to conventional ones, with the struts essentially undergoing only axial tension and compression forces (little to no torsion or moments transmitted) due to the ‘striction’ section (based on the feature dimensions and material mechanical properties) and thus without having any moving parts and/or moment/torsion releasing features such as clevises, ball joints, etc. This allows for a significant simplification of the structural analysis of the overall spaceframe structure.

Another advantage of the present invention is the significant simplification of the overall axial Coefficient of Thermal Expansion (CTE) optimization and analysis of the overall spaceframe structure with simple analysis tool such as a conventional spreadsheet rather than expensive specialized tools (such as finite element analysis tools or the like).

Another advantage of the present invention is that the node and/or strut for spaceframe structures allow for reduced overall weight, design and analysis times and costs, and manufacturing time and cost.

A further advantage of the present invention is that the nodes for spaceframe structures are relatively easy to manufacture and allows for relatively easy structural analysis with the presence of a neck or ‘striction’ region of reduced cross-section area at each extremity of the struts to essentially significantly reduce transfer of flexure moments and torsions between the struts and the nodes without having complex mechanical joints such as ball joints and the like, as well as to reduce the weight of the nodes.

Still another advantage of the present invention is that the struts for spaceframe structures typically include two tubular axial sections made out of different materials with different coefficients of thermal expansion (CTEs) in order to ‘tune’ the overall axial CTE of the strut (essentially from one intersection point with other struts at a node to the other intersection point intersecting with different struts at the other node) by selecting proper materials and lengths of the two sections. The tuning of the different strut CTEs allow for the control of the variation of the spaceframe structure deformation over temperature (Thermo-Elastic Distortion—TED). The effective strut CTE is generally identical for all struts, and is typically near zero, thus ensuring little to no temperature-induced deformation of the spaceframe structure.

Yet another advantage of the present invention is that the assembly of each strut is made in parallel with the connection of the tubes with the two adjacent nodes of the spaceframe structure, thereby reducing time and complexity of the assembly and necessitating no specific order of assembly hence providing full flexibility in the assembly sequence, and allows for easy repair/replacement of parts.

Yet a further advantage of the present invention is that the different nodes are easily and rapidly designed and manufactured by various means (including convention/CNC (Computer Numerically Controlled) milling/turning, Additive Manufacturing (AM), and the like), strut end-fittings are simple and stocked or rapidly procured or machined, and strut sections (or tubes) are rapidly obtained from respective standardized tubular materials, cut to length on demand.

Still another advantage of the present invention is that the struts for spaceframe structures include two end-fittings, when manufactured separately, can be made out of materials (Titanium, Invar, Kovar, graphite, etc.) with specific coefficients of thermal expansion (CTEs) in order to further ‘tune’ the overall axial CTE of the strut (essentially from one intersection point with other struts at a node to the other intersection point intersecting with different struts at the other node) by selecting proper materials for the end-fittings. The tuning of the different strut CTEs allow for the control of the variation of the spaceframe structure deformation over temperature (Thermo-Elastic Distortion—TED). The effective strut CTE is generally identical for all struts, and is typically near zero, thus ensuring little to no temperature-induced deformation of the spaceframe structure.

According to an aspect of the present invention there is provided a node device for connecting to at least one strut having a strut bending stiffness (E_{S}I_{S}) and defining a generally rectilinear strut axis, said node device comprising:
a main body; and
at least one arm connecting to and extending from the main body along the strut axis and toward the at least one strut, the at least one arm having a node (proximal) end attaching to the main body, a strut (distal) end for connecting to the at least one strut and a midsection extending between the node end and the strut end, the midsection including a neck portion having a neck bending stiffness (E_{N}I_{N}) being less than about 20% of the strut bending stiffness.

In one embodiment, the at least one strut has a strut length (L_{S}) to define a strut bending stiffness per unit length (E_{S}I_{S}/L_{S}) and the neck portion has a neck portion length (L_{N}) to define a neck bending stiffness per unit length (E_{N}I_{N}/L_{N}), the neck bending stiffness per unit length being less than about 600%, typically less than about 300%, and preferably less than about 150% of the strut bending stiffness per unit length.

In one embodiment, the at least one arm includes a plurality of arms for connecting to a plurality of struts, each one of the plurality of arms connecting to a respective one of the plurality of struts, and the neck portion of each one of the plurality of arms having a neck bending stiffness being less than about 20% of the strut bending stiffness of the respective one of the plurality of struts.

Conveniently, all strut axes of the plurality of struts intersect with each other at an axis intersecting point located adjacent (or circumscribed by) the main body, each one of the plurality of arms extending from the main body along the respective strut axis and away from the axis intersecting point.

In one embodiment, the neck portion has a neck bending stiffness being less than about 10%, and preferably less than about 5% of the corresponding strut bending stiffness.

In one embodiment, the main body and the plurality of arms integrally form a single piece.

In one embodiment, each strut end, preferably releasably, connects to the respective strut via a strut end-fitting.

In accordance with another aspect of the present invention there is provided a strut device for use in a frame structure and for mounting between first and second fixed nodes having first and second strut end-fittings, respectively, the strut device comprising:
a primary section having first and second primary ends and defining a strut axis therebetween; and
a secondary section having first and second secondary ends, the second primary end axially slidably connecting onto the first secondary end between a first configuration in which the first primary end and the second secondary end are positionable adjacent the first and second end-fittings respectively for axial positioning of the strut device therebetween, and a second configuration in which the first primary end and the second secondary end are axially overlapping the first and second end-fittings respectively for securing thereto with the primary and secondary sections securing to one another.

In one embodiment, the primary and secondary sections are cylindrical, preferably tubular in shape.

In one embodiment, the primary section has a first length and is made out of a first material having a first axial coefficient of thermal expansion, and the secondary section has a second length and is made out of a second material having a second axial coefficient of thermal expansion, the first and second lengths being defined to provide the strut device with a predetermined combined axial strut coefficient of thermal expansion.

In accordance with another aspect of the present invention there is provided a spaceframe structure, comprising:
at least one strut having a strut bending stiffness (E_{S}I_{S}) and defining a generally rectilinear strut axis;
at least one node connecting to of the at least one strut, said at least one node including:
   a main body; and
   at least one arm connecting to and extending from the main body along the strut axis and toward the at least one strut, the at least one arm having a node (proximal) end attaching to the main body, a strut (distal) end connecting to the at least one strut and a midsection extending between the node end and the strut end, the midsection including a neck portion having a neck bending stiffness (E_{N}I_{N}) being less than about 20% of the strut bending stiffness.

In one embodiment, the at least one strut has a strut length (L_{S}) to define a strut bending stiffness per unit length (E_{S}I_{S}/L_{S}) and the neck portion has a neck portion length (L_{N}) to define a neck bending stiffness per unit length (E_{N}I_{N}/L_{N}), the neck bending stiffness per unit length being less than about 600%, typically less than about 300%, and preferably less than about 150% of the strut bending stiffness per unit length.

In one embodiment, the at least one arm includes a plurality of arms for connecting to a plurality of struts, each one of the plurality of arms connecting to a respective one of the plurality of struts, and the neck portion of each one of the plurality of arms having a neck bending stiffness being less than about 20% of the bending stiffness of the respective one of the plurality of struts.

Conveniently, all strut axes of the plurality of struts intersect with each other at an axis intersecting point located adjacent (or circumscribed by) the main body, each one of the plurality of arms extending from the main body along the respective strut axis and away from the axis intersecting point.

In one embodiment, at least one of said plurality of struts is located between two adjacent ones of said plurality of nodes. Preferably, the at least one of said plurality of struts being located between two adjacent ones of said plurality of nodes has a predetermined combined axial strut coefficient of thermal expansion. Conveniently, the predetermined combined axial strut coefficient of thermal expansion takes into consideration the respective one of said plurality of arms from each said two adjacent ones of said plurality of nodes connecting to the at least one of said plurality of struts.

In one embodiment, the at least one strut includes:
a primary section having first and second primary ends with the strut axis extending therebetween; and
a secondary section having first and second secondary ends, the second primary end axially slidably connecting onto the first secondary end between a first configuration in which the first primary end and the second secondary end are positionable adjacent first and second end-fittings respectively for axial positioning of the at least one strut therebetween, and a second configuration in which the first primary end and the second secondary end are axially overlapping the first and second end-fittings respectively for securing thereto with the primary and secondary sections securing to one another, at least one of the first and second end-fittings connecting to the strut end of the at least one arm.

In one embodiment, the primary section has a first length and is made out of a first material having a first axial coefficient of thermal expansion, and the secondary section has a second length and is made out of a second material having a second axial coefficient of thermal expansion, the first and second lengths being defined to provide the at least one strut with a predetermined combined axial strut coefficient of thermal expansion.

Conveniently, the predetermined combined axial strut coefficient of thermal expansion takes into consideration the respective one of said at least one arm of said at least one node connecting to the at least one strut.

Conveniently, the predetermined combined axial strut coefficient of thermal expansion of all of the at least one strut is essentially identical.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a perspective view of a spaceframe structure in accordance with an embodiment of the present invention;

FIG. 2 is a broken enlarged perspective view of a 6-arm node with connecting struts of the embodiment of FIG. 1;

FIG. 3 is a top side perspective view of a 2-arm base node with connecting struts of the embodiment of FIG. 1;

FIG. 4 is a perspective view of the node of FIG. 2 with the connecting end-fittings of the connecting struts;

FIG. 5 is an exploded perspective view of the node of FIG. 4, showing the end-fitting connected thereto;

FIG. 6 is a perspective section view taken along line 6-6 of FIG. 4;

FIG. 7 is an exploded elevation view of a strut of the embodiment of FIG. 1, shown between the two nodes in a first insertion configuration with the two strut sections (or tubes) inserted between the two end-fittings secured to the nodes;

FIG. 8 is a view similar to FIG. 7 but not exploded, showing the strut in the first insertion configuration with one of the two tubes slidably telescopically connected to one another and inserted between the two end-fittings;

FIG. 9 is a view similar to FIG. 8, showing the strut in a second fully installed configuration with the two tubes connected to the two end-fittings and telescopically connected to one another; and

FIG. 10 is a schematic bottom perspective view of another embodiment of a spaceframe structure in accordance with the present invention that is used to support an antenna reflector.

### DETAILED DESCRIPTION OF THE INVENTION

With reference to the annexed drawings the preferred embodiment of the present invention will be herein described for indicative purpose and by no means as of limitation.

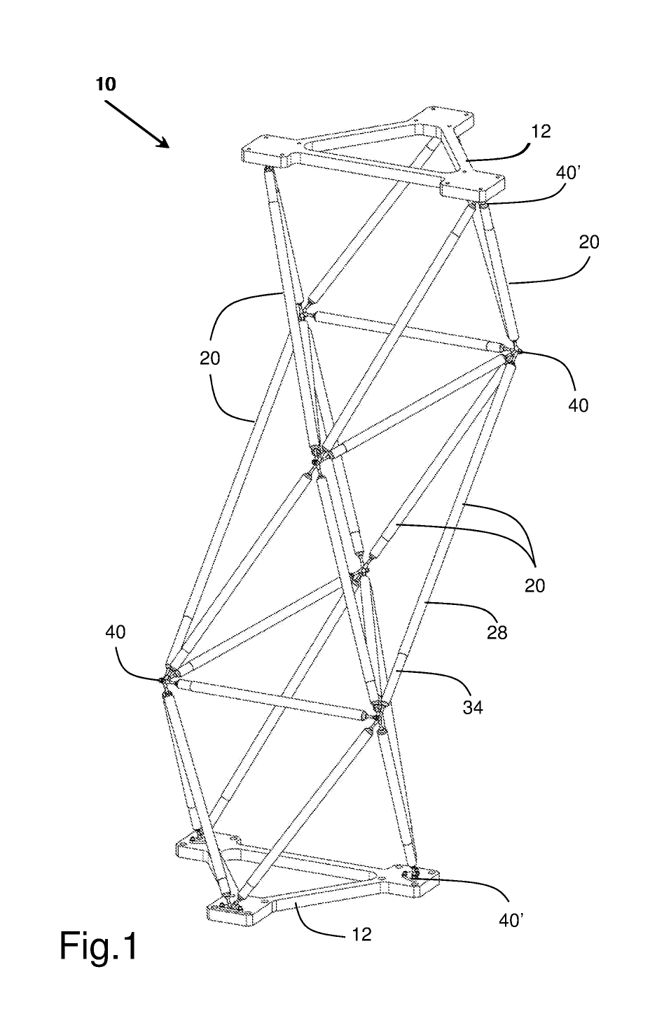

Referring to FIGS. 1 to 5, there is shown a spaceframe structure or assembly in accordance with an embodiment 10 of the present invention, typically for use onboard of spacecraft or the like.

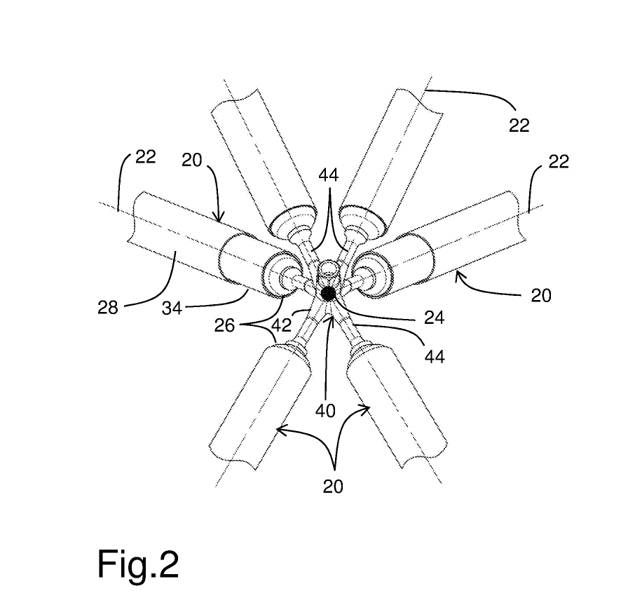

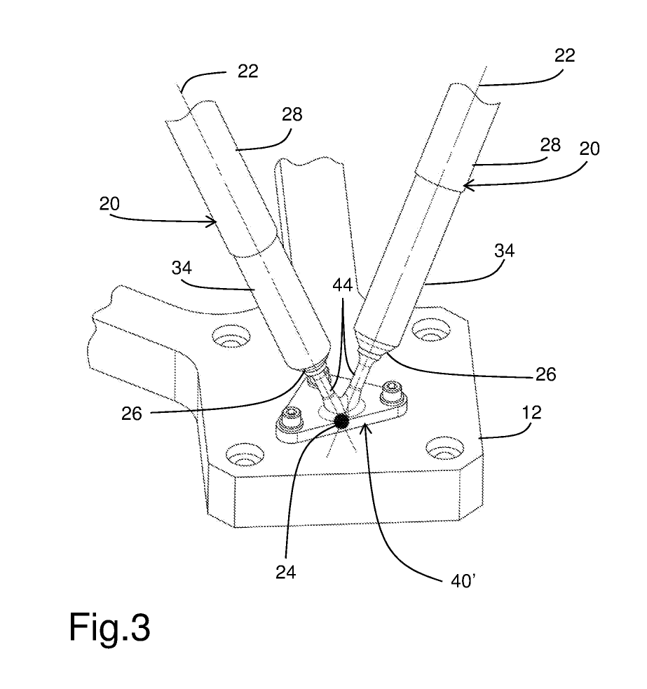

Referring more specifically to FIG. 1, the structure 10 typically includes a plurality of struts 20 interconnected to a plurality of nodes (or joints or hubs) 40. Each strut 20 defines a generally rectilinear strut axis 22 and has a strut bending stiffness E_{S}I_{S} (or the lowest thereof—see hereinafter for details) about that strut axis 22. The bending stiffness essentially refers to the Young Modulus (E_{S}) of the material of the strut times the inertia (I_{S}) of the geometry of the strut cross-section. Each node 40 connects to plurality of struts 20, with each strut 20 being located between two adjacent nodes 40. All struts 20 that connect to a same node 40 have the respective strut axes 22 intersecting with each other at an axis intersecting common point 24, as seen in FIGS. 2 and 3.

Each node 40 includes a main body 42 located adjacent (or circumscribing in the case of inter-strut nodes (see FIGS. 2 and 4-6), as opposed to base nodes 40′ (see FIG. 3) used to secure the structure to a panel 12, other equipment or the like) the axis intersecting point 24, and, for each strut 20 connecting thereto, an arm 44 connecting to and extending from the main body 42 along the respective strut axis 22 and away from the axis intersecting point 24. Each arm 44 has a node (proximal) end 46 attaching to the main body 42, a strut (distal) end 48 connecting to the respective strut 20 and a midsection 50 extending between the node end 46 and the strut end 48. The midsection 50 includes a neck portion (or striction) 52 having a (lowest) neck cross-sectional bending stiffness (E_{N}I_{N}) (Young's or elastic modulus E_{N}× area moment of inertia I_{N} of the neck portion 52) about the strut axis 22 being less than about 20%, typically less than about 10%, and preferably less than about 5% of the corresponding strut cross-sectional bending stiffness (E_{S}I_{S}) about the strut axis 22. Essentially, the neck portion 52 has a bending stiffness (E_{N}I_{N}) sufficiently low to significantly release structural moments at the hub end 46.

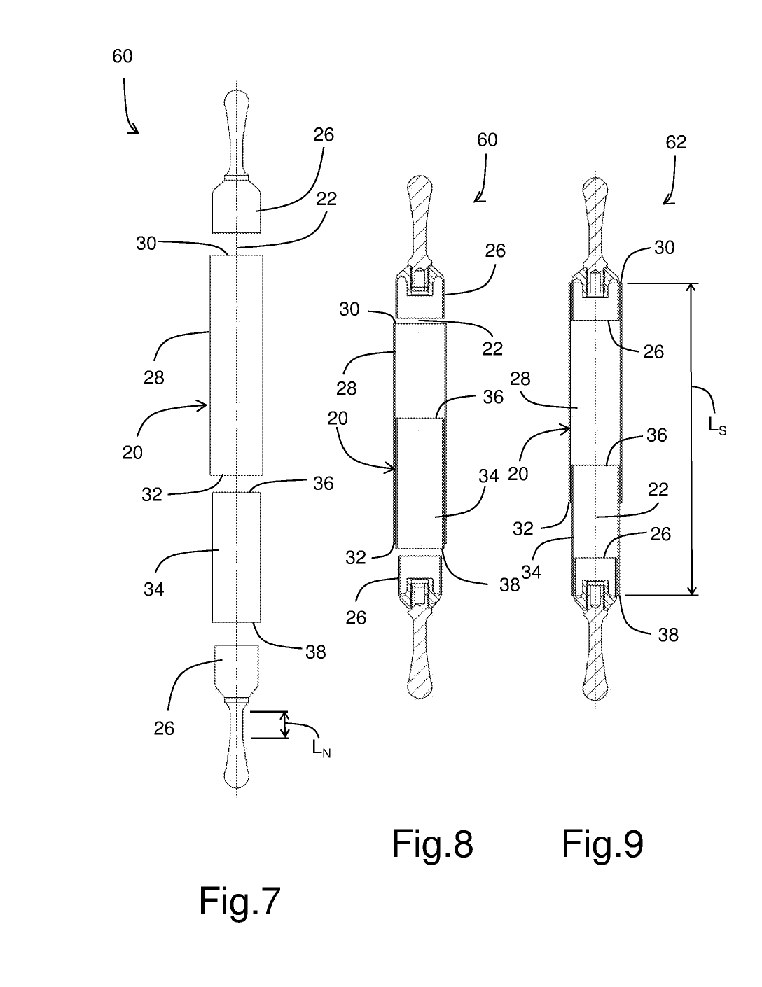

Alternatively, since the length (L_{S}) of each strut 20 (as shown in FIG. 9) may considerably vary, as opposed to the length (L_{N}) of the neck portion 52 (as shown in FIGS. 5 and 7), the ratio of the area bending stiffness per unit length (E_{N}I_{N}/L_{N}) of the neck portion 52 is alternatively less than about 600%, typically less than about 300%, and preferably less than about 150% of the corresponding tube bending stiffness per unit length (E_{S}I_{S}/L_{S}).

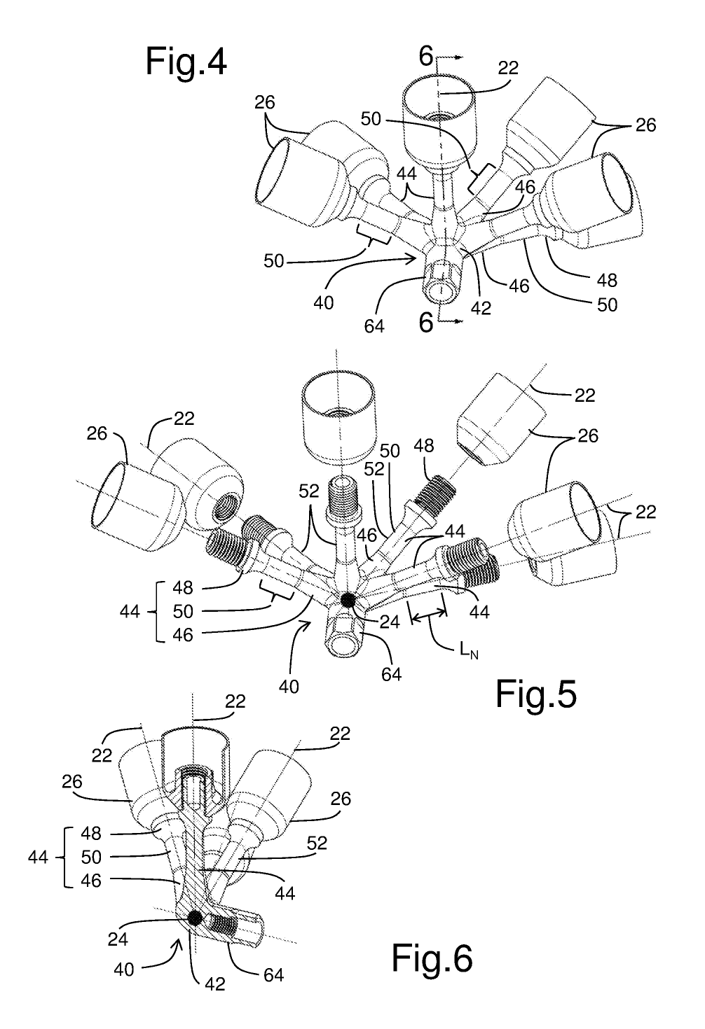

Preferably, the main body 42 and the plurality of arms 44 integrally form a single node piece 40. As better seen in FIGS. 4 and 5, the strut end 48 of each arm 44 typically releasably connects to a strut end-fitting 26, preferably using an axial threaded connection or the like.

Typically, in order to be able to connect each strut 20 between the corresponding two nodes 40 that are already positioned relative to one another, the strut 20 includes a first (or primary) section 28 having first 30 and second 32 primary ends and a second (or secondary) section 34 having first 36 and second 38 secondary ends. The second primary end 32 axially slidably connects onto the first secondary end 36 (in a telescopic manner) between a first (insertion) configuration 60 in which the first primary end 30 and the second secondary end 38 are positionable adjacent the corresponding strut end-fittings 26 respectively for axial positioning of the strut 20 there between (as shown in FIGS. 7 and 8), and a second (installed) configuration 62 in which the first primary end 30 and the second secondary end 38 axially overlap (via axial slidable insertion of one over the other, preferably of the strut end 30, 38 over the end-fittings 26) the corresponding strut end-fittings 26 respectively for securing thereto with the first 28 and second 34 sections securing to one another with a remaining overlap there between (as shown fully installed in FIG. 9). Once in the second configuration 62, all parts are typically bonded together. Typically, at least one, and preferably all of the struts 20 are telescopic within a spaceframe structure 10.

In order to ease the analysis and the assembly of the spaceframe structure 10, all cross-sections of the arms 44, end-fittings 26 and strut sections (or tubes) 28, 34 are preferably axisymmetric or circular, with the end-fittings 26 and tubes 28, 34 being typically cylindrical and preferably hollowed or tubular in shape.

In order to control the overall coefficient of thermal expansion (CTE) of each strut 20, the first 28 and second 34 section are typically made of different first and second materials having first and second axial CTEs, respectively, and have predetermined first L1 and second L2 lengths. The first and second lengths, along with the first and second CTEs are determined to provide the predetermined combined axial coefficient of thermal expansion of the strut 20, typically taking all materials into consideration between the two intersection points 24 positioned onto the axis 22 of the strut 20, i.e. including the portions of the main bodies 42, the two arms 44 and the two end-fittings 26 connecting to the same strut 20 and all bonding adhesives (with the respective lengths along the strut axis 22). This tuning of each strut CTE, preferably with all strut CTEs of a same assembly being essentially identical and preferably around zero, enables to easily control the Thermo-Elastic Distortion (TED) behavior of the spaceframe structure 10 over temperature. Typical materials used for the different strut sections 28, 34 and end-fittings 26 could be different composite materials, different steels, titanium and other alloys and the like. Depending on the selected materials for each strut 20, the lowest area bending stiffness of the two sections 28, 34 and end-fittings 26 will be considered as being the strut bending stiffness (E_{S}I_{S}). In other words, the bending stiffness of a strut 20 is essentially the lowest bending stiffness over the entire length of the strut.

During the manufacturing/assembly sequence of the spaceframe structure 10, when a strut 20 is being assembled and connected at its ends 30, 38 to the two nodes 40 via the end-fittings 26, each node 40 that is not a base node 40′ typically includes a tooling interface/grappling feature 64, extending from the main body 42 (similarly to an arm 44), that is typically used to interface with a robot or the like (not shown) which acts as a positioning device, as better shown in FIGS. 4-6. The tooling feature 64 is also typically used as an alignment reference feature, attachment point for thermal blankets (not shown), or the like.

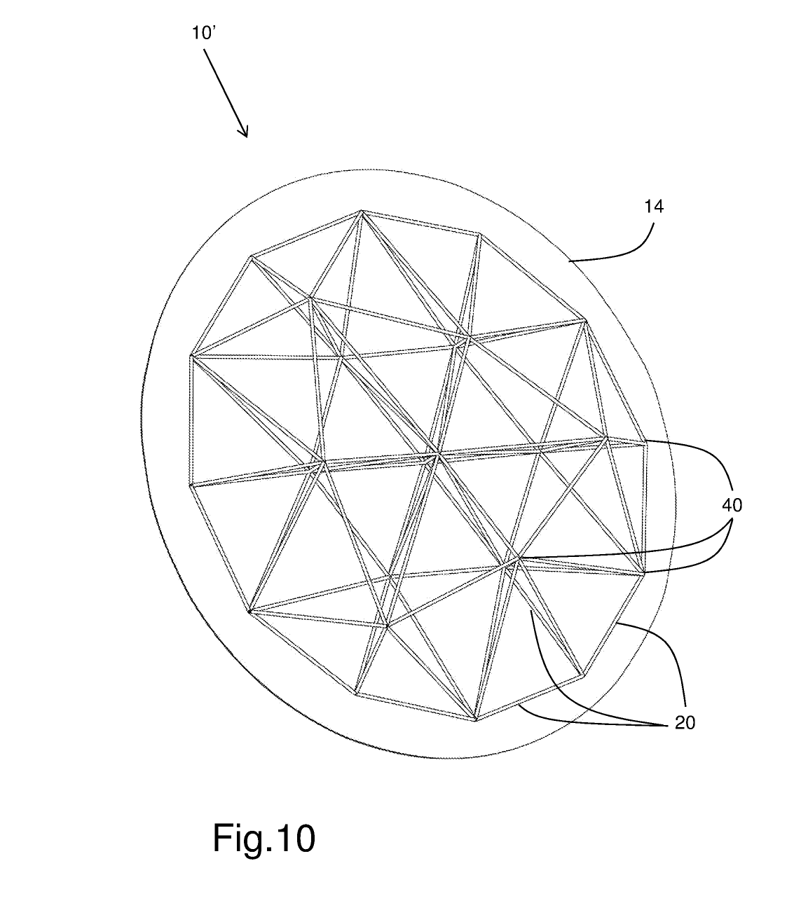

In FIG. 10, there is shown another embodiment 10′ of a spaceframe structure in accordance with the present invention, in which the structure 10′ including a plurality of nodes 40 (partially illustrated) and struts 20 supports an antenna reflector 14.

Although not illustrated, one skilled in the art would readily realize that, without departing from the scope of the present invention, the struts 20 could be made out of only one or more than two sections 28, 34 of different materials if required, and that spaceframe described within is not limited to spacecrafts and/or antennas as described as the preferred embodiments. Furthermore, in the embodiments 10, 10′ illustrated and described hereinabove, the arms 44 are preferably integrally made out of the same piece of material (via machining, 3D-printing and the like) of the main body 42 and attached to (bonding, screwing and the like) the end-fittings 26, but could be, without departing from the scope of the present invention, either different pieces than the main body 42 and the strut end-fittings 26 and connected thereto, or be integral with the end-fittings 26 only (not the main body 42).

Although the present invention has been described with a certain degree of particularity, it is to be understood that the disclosure has been made by way of example only and that the present invention is not limited to the features of the embodiments described and illustrated herein, but includes all variations and modifications within the scope of the invention as hereinabove described and hereinafter claimed.

We claim:

1. A node device for connecting to at least one strut having a strut bending stiffness and defining a generally rectilinear strut axis, said node device comprising:
a main body; and
at least one arm connecting to and extending from the main body along the strut axis and toward the at least one strut, the at least one arm having a node end attaching to the main body, a strut end for connecting to the at least one strut and a midsection extending between the node end and the strut end, the midsection including a neck portion having a neck bending stiffness being less than about 20% of the strut bending stiffness.

2. The node device of claim 1, wherein the at least one strut has a strut length to define a strut bending stiffness per unit length and the neck portion has a neck portion length to define a neck bending stiffness per unit length, the neck bending stiffness per unit length being less than about 600% of the strut bending stiffness per unit length.

3. The node device of claim 1, wherein the at least one arm includes a plurality of arms for connecting to a plurality of struts, each one of the plurality of arms connecting to a respective one of the plurality of struts, and the neck portion of each one of the plurality of arms having a neck bending stiffness being less than about 20% of the strut bending stiffness of the respective one of the plurality of struts.

4. The node device of claim 3, wherein all strut axes of the plurality of struts intersect with each other at an axis intersecting point located adjacent the main body, each one of the plurality of arms extending from the main body along the respective strut axis and away from the axis intersecting point.

5. The node device of claim 1, wherein the main body and the plurality of arms integrally form a single piece.

6. The node device of claim 1, wherein each strut end, preferably releasably, connects to the respective strut via a strut end-fitting.

7. A spaceframe structure, comprising:
at least one strut having a strut bending stiffness and defining a generally rectilinear strut axis;
at least one node connecting to of the at least one strut, said at least one node including:
a main body; and
at least one arm connecting to and extending from the main body along the strut axis and toward the at least one strut, the at least one arm having a node end attaching to the main body, a strut end connecting to the at least one strut and a midsection extending between the node end and the strut end, the midsection including a neck portion having a neck bending stiffness being less than about 20% of the strut bending stiffness.

8. The spaceframe structure of claim 7, wherein the at least one strut has a strut length to define a strut bending stiffness per unit length and the neck portion has a neck portion length to define a neck bending stiffness per unit length, the neck bending stiffness per unit length being less than about 600% of the strut bending stiffness per unit length.

9. The spaceframe structure of claim 7, wherein the at least one arm includes a plurality of arms for connecting to a plurality of struts, each one of the plurality of arms connecting to a respective one of the plurality of struts, and the neck portion of each one of the plurality of arms having a neck bending stiffness being less than about 20% of the bending stiffness of the respective one of the plurality of struts.

10. The spaceframe structure of claim 9, wherein all strut axes of the plurality of struts intersect with each other at an axis intersecting point located adjacent the main body, each one of the plurality of arms extending from the main body along the respective strut axis and away from the axis intersecting point.

11. The spaceframe structure of claim 9, wherein at least one of said plurality of struts is located between two adjacent ones of said plurality of nodes.

12. The spaceframe structure of claim 11, wherein the at least one of said plurality of struts being located between two adjacent ones of said plurality of nodes has a predetermined combined axial strut coefficient of thermal expansion.

13. The spaceframe structure of claim 12, wherein the predetermined combined axial strut coefficient of thermal expansion takes into consideration the respective one of said plurality of arms from each said two adjacent ones of said plurality of nodes connecting to the at least one of said plurality of struts.

14. The spaceframe structure of claim 7, wherein the at least one strut includes:
a primary section having first and second primary ends with the strut axis extending therebetween; and
a secondary section having first and second secondary ends, the second primary end axially slidably connecting onto the first secondary end between a first configuration in which the first primary end and the second secondary end are positionable adjacent first and second end-fittings respectively for axial positioning of the at least one strut therebetween, and a second configuration in which the first primary end and the second secondary end are axially overlapping the first and second end-fittings respectively for securing thereto with the primary and secondary sections securing to one another, at least one of the first and second end-fittings connecting to the strut end of the at least one arm.

15. The spaceframe structure of claim 14, wherein the primary section has a first length and is made out of a first material having a first axial coefficient of thermal expansion, and the secondary section has a second length and is made out of a second material having a second axial coefficient of thermal expansion, the first and second lengths being defined to provide the at least one strut with a predetermined combined axial strut coefficient of thermal expansion.

16. The spaceframe structure of claim 15, wherein the predetermined combined axial strut coefficient of thermal expansion takes into consideration the respective one of said at least one arm of said at least one node connecting to the at least one strut.

17. The spaceframe structure of claim 16, wherein the predetermined combined axial strut coefficient of thermal expansion of all of the at least one strut is essentially identical.

18. A strut device for use in a frame structure and for mounting between first and second fixed nodes having first and second strut end-fittings, respectively, the strut device comprising:
a primary section having first and second primary ends and defining a strut axis therebetween; and
a secondary section having first and second secondary ends, the second primary end axially slidably connecting onto the first secondary end between a first configuration in which the first primary end and the second secondary end are positionable adjacent the first and second end-fittings respectively for axial positioning of the strut device therebetween, and a second configuration in which the first primary end and the second secondary end are axially overlapping the first and second end-fittings respectively for securing thereto with the primary and secondary sections securing to one another.

19. The strut device of claim 18, wherein the primary section has a first length and is made out of a first material having a first axial coefficient of thermal expansion, and the secondary section has a second length and is made out of a second material having a second axial coefficient of thermal expansion, the first and second lengths being defined to provide the strut device with a predetermined combined axial strut coefficient of thermal expansion.

20. The strut device of claim 18, wherein the primary and secondary sections are cylindrical in shape.
